(19) United States
(12) Patent Application Publication
(10) Pub. No.: US 2016/0190853 A1
(43) Pub. Date: Jun. 30, 2016

(54) PORTABLE CHARGING STATION HAVING A POWER SOURCE AND A WIRELESS POWER TRANSMITTER TO TRANSMIT POWER TO A PORTABLE ELECTRONIC DEVICE HAVING A WIRELESS POWER RECEIVER

(71) Applicant: AFC TRIDENT, INC., Ontario, CA (US)

(72) Inventors: Hong Lip YOW, Chino, CA (US); Ching C. KOEY, Eastvale, CA (US); Sam PYO, La Habra, CA (US); Roberto LUNA, Riverside, CA (US)

(21) Appl. No.: 14/588,356

(22) Filed: Dec. 31, 2014

(51) Int. Cl. H02J 7/02; H02J 7/00

(52) U.S. Cl. CPC H02J 7/025; H02J 7/0044

(57) ABSTRACT

Provided is a portable charging station for a portable electronic device having a wireless power receiver to supply power to the portable electronic device. The portable charging station comprises a base having a wireless power transmitter and a battery source providing power to the wireless power transmitter and an attachment structure to position the portable electronic device to engage the base at a location where the wireless power transmitter is in transmission range from the wireless power receiver, wherein the wireless power transmitter is configured to transmit power from the battery source to the wireless power receiver when the portable electronic device is engaged to the base by the attachment structure.

### BACKGROUND OF THE INVENTION

1. Field of the Invention

The present invention relates to an apparatus, system, and method for using a portable charging station having a power source and a wireless power transmitter to transmit power to a portable electronic device having a wireless power receiver

2. Description of the Related Art

Smartphones may include a wireless power receiver to receive wireless power transmitted from a wireless power transmitter using wireless power transmission technology such as Qi™ wireless charging technology or other wireless charging technologies such as Power Matters Alliance (PMA), Rezence®, WiPower®, etc. (QI is a trademark of the Wireless Power Consortium, Rezence® is a registered trademark of the Alliance for Wireless Power, and WiPower is a registered trademark of PowerPad Inc.). Wireless charging stations may take the form of a pad, docking station, and other structures connected to a power source by a power cord to charge a wireless device having a wireless power receiver.

### SUMMARY

Provided is a portable charging station for a portable electronic device having a wireless power receiver to supply power to the portable electronic device. The portable charging station comprises a base having a wireless power transmitter and a battery source providing power to the wireless power transmitter and an attachment structure to position the portable electronic device to engage the base at a location where the wireless power transmitter is in transmission range from the wireless power receiver, wherein the wireless power transmitter is configured to transmit power from the battery source to the wireless power receiver when the portable electronic device is engaged to the base by the attachment structure.

Provided is portable charging station for a portable electronic device having a wireless power receiver to supply power to the portable electronic device, comprising a pouch having a wireless power transmitter and a battery source, wherein the wireless power transmitter is configured to transmit power from the battery source to the wireless power receiver when the portable electronic device is positioned within the pouch.

Provided is a portable charging system for charging a portable electronic device, comprising: a power receiving case for the portable electronic device forming an enclosure in which the portable electronic device is inserted, comprising: an attachment structure for coupling to the portable electronic device; a wireless power receiver; and a power interface coupling the wireless power receiver to an interface on the portable electronic to allow the transmission of power from the wireless power receiver to the portable electronic device when the portable electronic device is coupled to the power receiving case. The system further includes a portable charging station comprising: a wireless power transmitter; a battery source to supply power to the wireless power transmitter to transmit to the wireless power receiver; and an attachment structure to guide the portable electronic device coupled to the power receiving case to a position with respect to the portable charging station where the wireless power transmitter is in power transmission range with the wireless power receiver.

Provided is a method for charging a portable electronic device having a wireless power receiver, comprising: attaching a portable charging station to a clothing accessory of a user of the portable charging station, wherein the portable charging station comprises an attachment structure for coupling to the portable electronic device, a battery source, and a wireless power transmitter coupled to the battery source to transmit power from the battery source to the wireless power receiver of the portable electronic device; and engaging the portable electronic device to the portable charging station, wherein the attachment structure positions the portable electronic device in the portable charging station to cause the wireless power transmitter to transmit power from the battery source to the wireless power receiver.

### BRIEF DESCRIPTION OF THE DRAWINGS

Embodiments are described by way of example, with reference to the accompanying drawings, which are not drawn to scale, wherein:

FIGS. 1a, 1b, 1c, 1d, 1e, 1f, and 1g illustrate a first embodiment of a portable charging station to charge a portable electronic device.

FIGS. 2 and 3 illustrate embodiments of a portable electronic device having a wireless power transmitter.

FIGS. 4a, 4b, 4c, 4d, and 4e illustrate a second embodiment of a portable charging station to charge a portable electronic device.

### DETAILED DESCRIPTION

In the current art, a charging station for a portable electronic device, such as a smartphone, having wireless power receiver capabilities comprises a relatively non-portable device such as a pad or docking station having a power cord to connect with an outlet to provide power to a wireless power transmitter to transmit to the wireless power receiver of the portable electronic device.

Described embodiments provide a portable charging station having a wireless power transmitter to allow for engagement with a portable electronic device, such as a smartphone supplied with a wireless power receiver. An attachment structure of the portable charging station positions the portable electronic device with respect to the portable charging station to be within the power transmission range of the wireless power transmitter. Described embodiments allow for portable charging of the portable charging device by allowing the portable charging station to be attached to the clothing of the user so the user may use wireless recharging to recharge a portable electronic device while the user is on the move.

Reference below will be made to the drawings wherein like structures may be provided with like reference designations. In order to show the structures of various embodiments most clearly, the drawings included herein include diagrammatic representations of components of the described embodiments. Thus, the actual appearance of the embodiments may appear different while still incorporating the claimed structures of the illustrated embodiments. Moreover, the drawings may show only the structures necessary to understand the illustrated embodiments. Additional structures known in the art have not been included to maintain the clarity of the drawings.

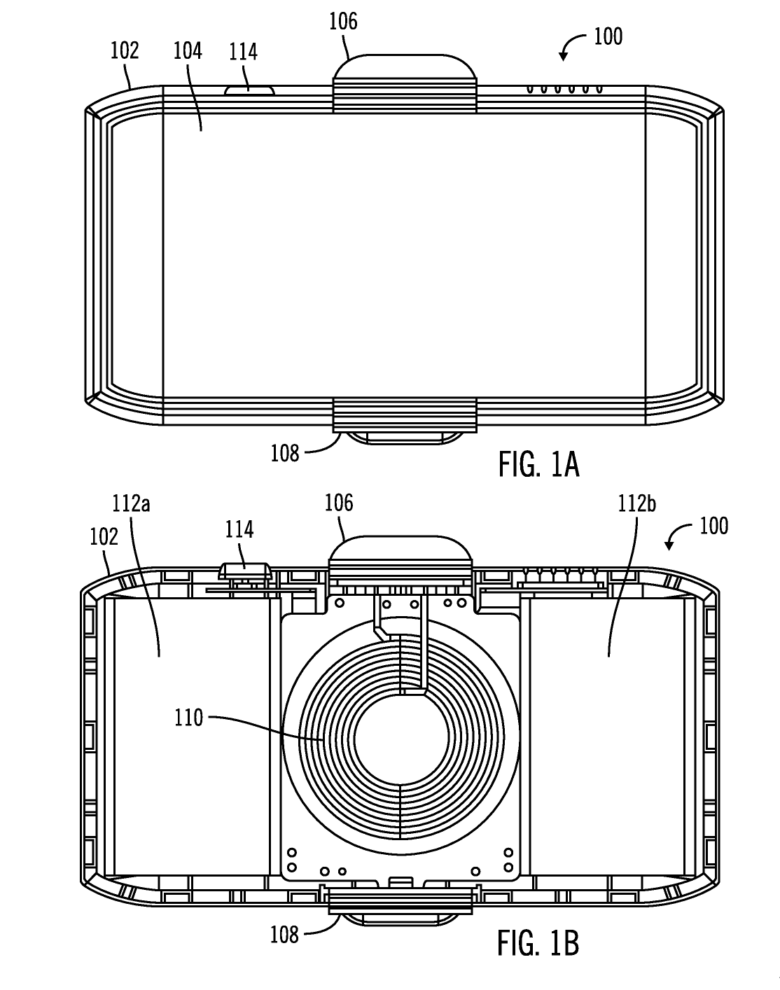

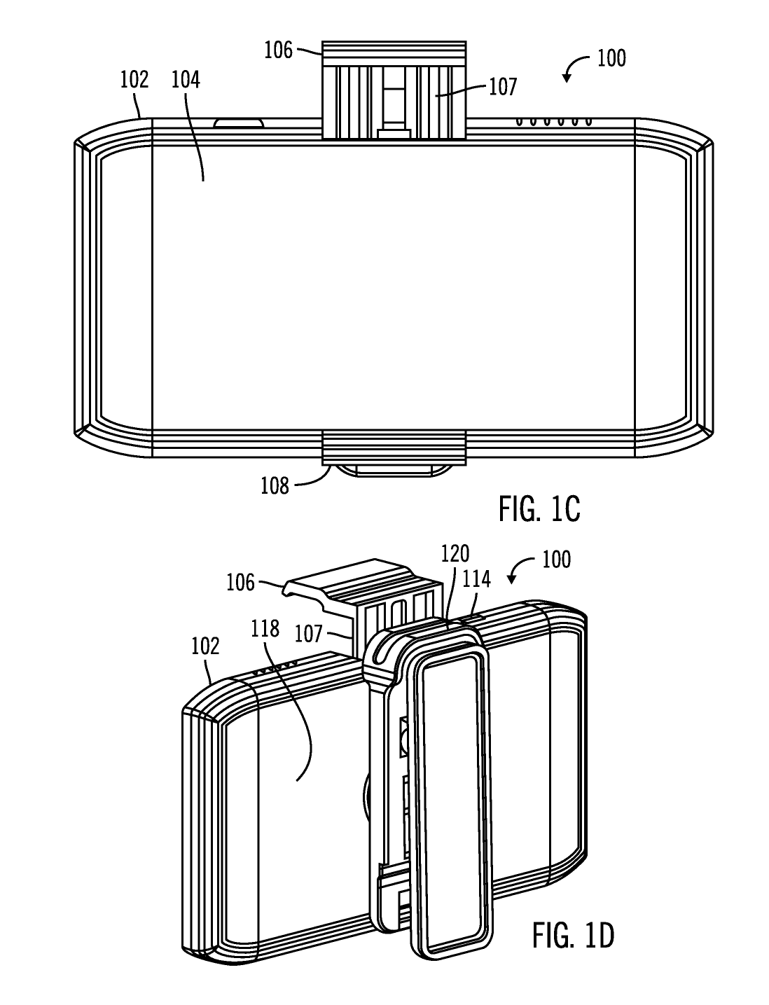

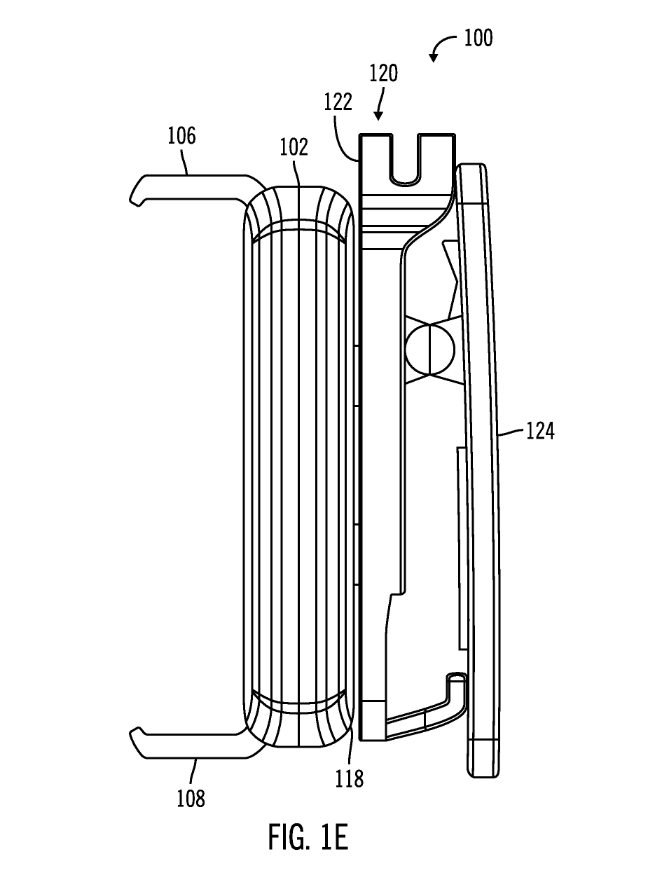

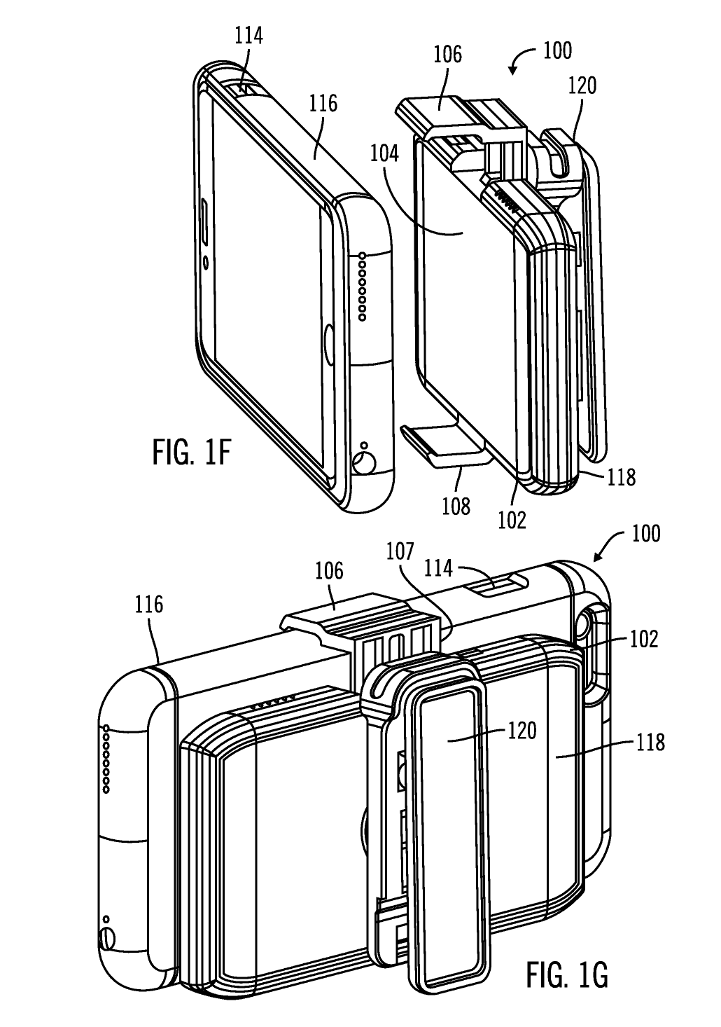

FIGS. 1a, 1b, 1c, 1d, 1e, 1f, and 1g illustrate an embodiment of a portable charging station 100 having a base 102 with a front surface 104 and an adjustable upper clip 106 and a lower clip 108 that may be fixed or adjustable. FIG. 1a shows a view of the front surface 104. FIG. 1b shows the arrangement of a transmitting power coil 110 and two batteries 112a, 112b that may be directly beneath the front surface 104. The batteries 112a, 112b are rechargeable and supply power to the transmitting power coil 110. In alternative embodiments, a different number of batteries may be used to implement the power source than the two that are shown. The transmitting power coil 110 may implement a wireless power transmitting technology that provides for inductive electrical power transmission, such as the Qi wireless charging technology or other wireless charging technologies such as Power Matters Alliance (PMA), Rezence, WiPower, etc. The batteries 112a, 112b are rechargeable via a power port 114, such as a micro-USB port.

FIGS. 1c, 1d, 1f, and 1g show the adjustable upper clip 106 having a shaft 107 that can be moved upward to extend the upper clip 106 away from the base 102 of the case to allow engagement with a portable electronic device 116 as shown in FIGS. 1f and 1g. FIGS. 1a, 1b and 1e show the adjustable upper clip 106 in a non-extended position. From the position shown in FIGS. 1a, 1b, and 1e, a user may adjust the adjustable upper clip 106 to extend away from the base 102 to allow the portable electronic device 116 to be positioned against the front surface 104 of the base 120. After engaging the portable electronic device 116 to the front surface 104, the user may then push the adjustable upper clip 106 downward to provide a secure and tight fit with the portable electronic device 116. In an alternative embodiment, both the upper 106 and lower 108 clips may be adjustable as described with respect to the upper clip 106. In a further alternative embodiment, the lower clip 108 may be adjustable as described with respect to clip 106 while the upper clip 106 remains fixed. The adjustable upper clip 106 may be spring loaded to maintain positions.

The attachment structure of the base 104 and clips 106, 108 allows for the positioning of the portable electronic device 116 with respect to the base 102 and wireless power transmitter 110 so that the wireless power receiver of the portable electronic device 116 is within power transmission range of the wireless power transmitter 110.

FIGS. 1d, 1e, 1f, and 1g show a back surface 118 of the portable charging station 100 to which a belt clip 120 is attached. The belt clip 120 allows attachment to a clothing accessory of the user, such as a shirt, pant waist, skirt waist, belt, strap, etc. As shown in FIG. 1e, the belt clip 120 has a fixed base 122 and an outer movable clip 124 that may be rotated away from the base 122 to allow positioning with respect to the user's clothing accessory.

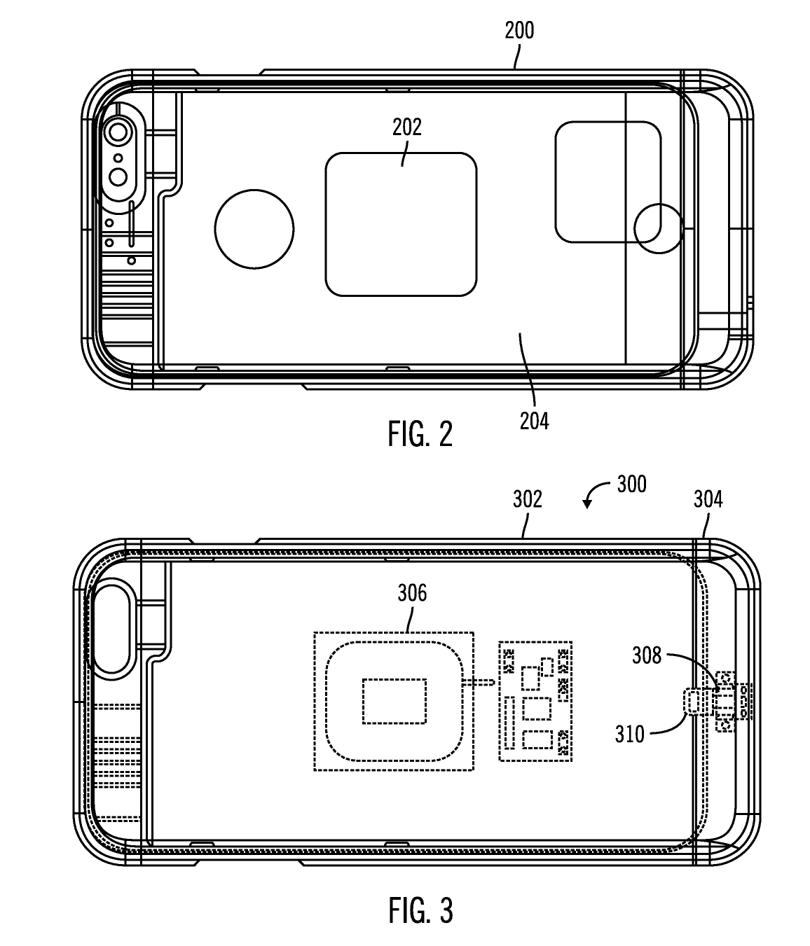

FIGS. 2 and 3 show embodiments of a portable electronic device 200 and 300, such as portable electronic device 116, having wireless power receiving capabilities. The portable electronic devices 116, 200, and 300 may comprise various portable computing devices, such as a smartphone, cellular phone, audio-video player, navigation system, etc.

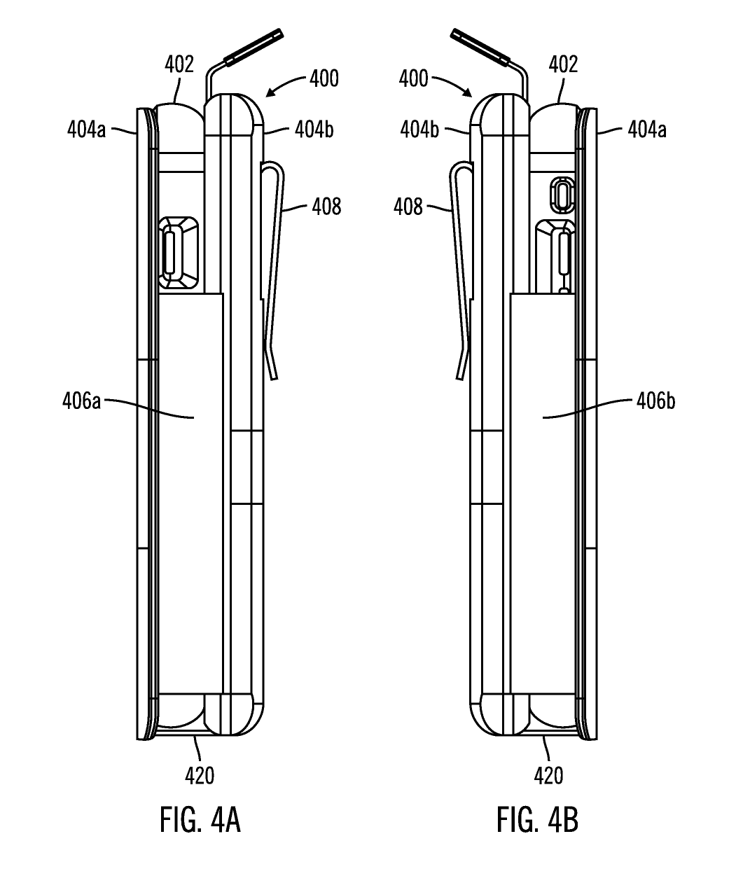

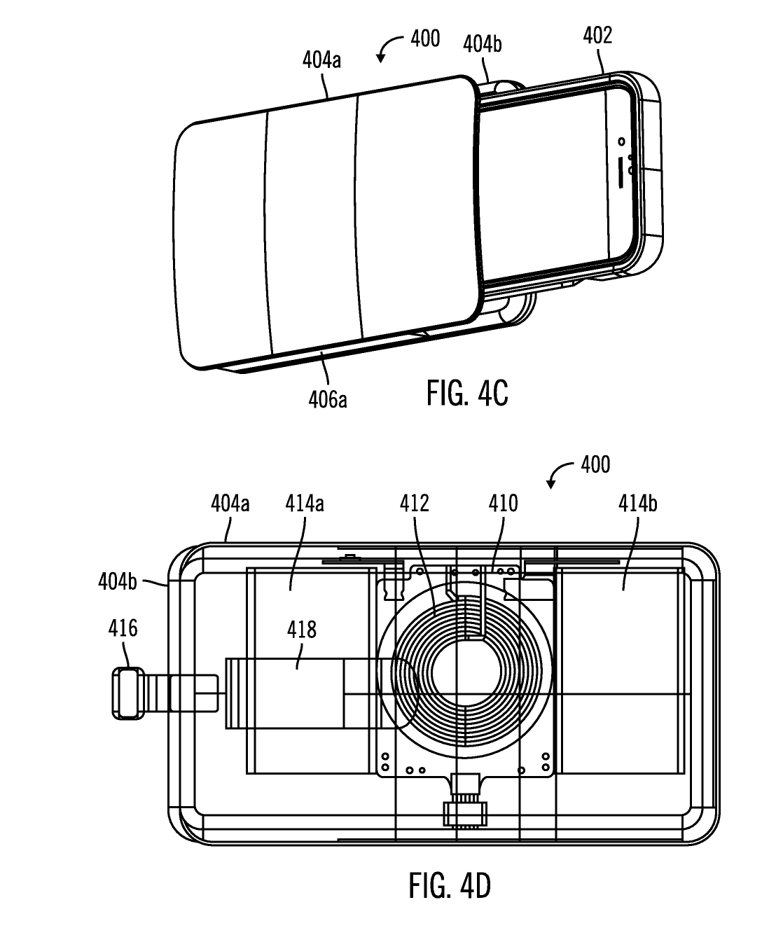

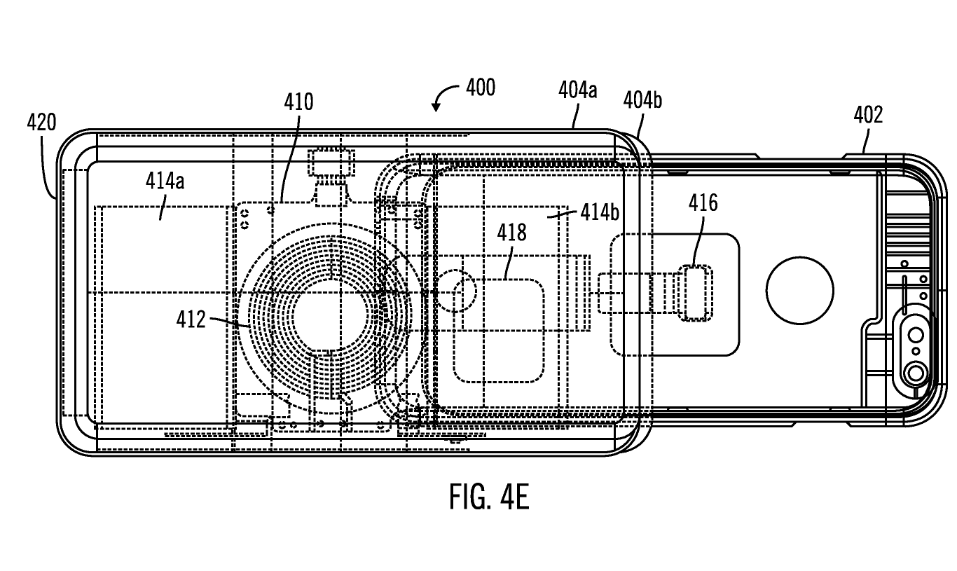

FIG. 2 shows a portable electronic device 200 in which a wireless power receiver 202 is included in a back surface 204 of the device 200. In this way, the wireless power receiver 202 is integrated within the component electronics of the portable electronic device 200. The wireless power receiver 202 is capable of receiving power transmitted by a wireless power transmitter 110 (FIG. 1b) and 410 (FIG. 4d)

FIG. 3 shows an alternative embodiment of a portable electronic device 300 comprising the electronic device component 302, such as the smartphone, cellular phone, audio-video player, etc., engaged with a portable power receiving case 304. The portable power receiving case 304 includes a wireless power receiver 306 to receive power from a wireless power transmitter 110 (FIG. 1b) and 410 (FIG. 4d). The power receiving case 304 includes an interface 308 including a plug or male connector to connect to a device interface 310 on the electronic device component 302 to transmit power captured by the wireless power receiver 304 to the electronic device component 302. In this way, the portable power receiving case 304 supplies power to the electronic device component 302.

FIGS. 4a, 4b, 4c, 4d, and 4e illustrate an additional embodiment of a portable charging station comprising a pouch 400 that can charge a portable electronic device 402 disposed within the pouch 400. The portable power transmitting pouch 400 is formed of a front side 404a, a back side 404b and connective material 406a, 406b (FIGS. 4a, 4b) connecting the sides. 404a, 404b. The pouch 400 further has a belt clip 408 on the back side 404b to clip onto the user's clothing accessory.

FIG. 4d illustrates a wireless power transmitter 410 having a coil 412 embedded within the back side 404b. The wireless power transmitter 410 includes two batteries 414a, 414b to supply power to the coil 412 to transmit power to a wireless power receiver 202 (FIG. 2) and 304 (FIG. 3). The front side 404a and the surface of the back side 404b are shown transparent to allow viewing of the wireless power transmitter 410. FIGS. 4d and 4e further show a pull tab 416 structure that has a ribbon 418 connected to the surface of the back side 404b to allow removal of the portable electronic device 402 from the pouch 400. The pouch 400 sides 404a, 404b and connective material 406a, 406b may be formed from a flexible material, such as cloth, leather, polyurethane, rubber, etc. In alternative embodiments, the pouch 400 may be formed of a hardened material, such as a relatively non-flexible metal or plastic. The back side 404b may be comprised of two layers of the material with the wireless power transmitter 410 structure contained between the two layers. Alternatively, the wireless power transmitter 410 may be located on an inner surface of back side 404b facing the portable electronic device 16.

FIG. 4e illustrates the portable electronic device 402 being inserted into the pouch 400. The coils 412 transmit wireless power to a wireless power receiver 418 on the portable electronic device 402 when the portable electronic device 402 is inserted in the pouch 400 attachment structure so as to be positioned at a bottom end 420 of the pouch 400.

FIGS. 1a and 1b show the portable charging stations 100 in a horizontal orientation with respect to the belt clip 120, such that a user would attach the portable electronic device 116 to the base 102 in a horizontal orientation. In an alternative embodiment, the base 102 may be positioned in a vertical orientation with respect to the belt clip 120 and be attached to the station 100 in the vertical orientation.

FIGS. 4a and 4b show the pouch 400 position in a vertical orientation with respect to the belt clip 408, such that a user would insert the portable electronic device 402 into the pouch 400 in a vertical orientation. In an alternative embodiment, the pouch 400 may be positioned in a horizontal orientation with respect to the belt clip 408 and be inserted into the pouch 400 in the horizontal orientation.

In FIGS. 1a-1g the portable charging station 100 has an attachment structure comprising clips 106 and 108 that are adjusted to engage the portable electronic device 116 to the front surface 104 of the portable charging station 100 so that the portable electronic device 116 and its wireless power receiver 202 (FIG. 2), 306 (FIG. 3) are positioned with respect to the base 102 to be in the power transmission range of the wireless power transmitter 110. In FIGS. 4a-4e the portable charging station 400 has an attachment structure comprising a pouch formed of sides 404a, 404b and connective material 406a, 406b such that portable electronic device 402 and its wireless power receiver 202 (FIG. 2), 306 (FIG. 3) are positioned within the pouch when completely inserted to the back end 420 of the pouch 400 to be in the power transmission range of the wireless power transmitter 410. In alternative embodiments, different attachment structures may be used to engage a portable electronic device having a wireless power receive to the portable charging station and to guide the portable electronic device into the portable charging station to allow power communication between the wireless power transmitter and the wireless power receiver.

In the described embodiments, the portable charging station is described as having one wireless power transmitter to charge one portable electronic device. In further embodiments, the portable charging station may include additional wireless power transmitters, such as additional transmitter coils, to charge additional portable electronic devices that may be engaged to the portable charging station and guided to be in the power transmission range of the wireless power transmitters.

In described embodiments, a belt clip is used to affix the portable charging station to a user's clothing accessory. In alternative embodiments, other fastening structures may be used to allow attachment of the belt clip to the clothing accessory, such as a magnetic clipping structure, a fastening structure using screws or additional clips or clamps, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Terms such as “top”, bottom”, “upper”, “lower”, “rear”, “front”, “back”, “outer”, “inner”, “bottom”, “left”, “right”, and the like may be used for descriptive purposes only and are not to be construed as limiting. Embodiments may be manufactured, used, and contained in a variety of positions and orientations.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

### Examples

The following are examples of embodiments.

Example 1 is a portable charging station for a portable electronic device having a wireless power receiver to supply power to the portable electronic device, comprising: a base having a wireless power transmitter and a battery source providing power to the wireless power transmitter; and an attachment structure to position the portable electronic device to engage the base at a location where the wireless power transmitter is in transmission range from the wireless power receiver, wherein the wireless power transmitter is configured to transmit power from the battery source to the wireless power receiver when the portable electronic device is engaged to the base by the attachment structure.

In Example 2, the subject matter of Example 1 can optionally include that the base includes a front surface to engage the portable electronic device and a back surface, and a first side and second side opposite the first side between the front and back surfaces, wherein the attachment structure comprises an adjustable first clip on the first side and a second clip on the second side, wherein the adjustable clip includes a shaft that is movable to position the adjustable clip away from the base.

In Example 3, the subject matter of Example 1 and 2 can optionally include that the base includes a front surface to engage the portable electronic device and a back surface, and a first side and second side opposite the first side between the front and back surfaces, and wherein the wireless power transmitter and the battery source are embedded in the base adjacent to the front surface and between the front and the back sides.

In Example 4, the subject matter of Examples 1-3 can optionally include that the battery source comprises a first battery located on a first side of the wireless power transmitter and a second battery located on a second side opposite the first side of the wireless power transmitter, wherein the first and second batteries supply power to the wireless power transmitter.

In Example 5, the subject matter of Example 1-4 can optionally include that the base has a substantially rectangular shape and wherein the wireless power transmitter is positioned at substantially at a center of the base along a length of the base.

In Example 6, the subject matter of Examples 1-5 can optionally include a belt clip on the back surface of the base to attach the portable charging station to a clothing accessory of a user.

Example 7 is a portable charging station for a portable electronic device having a wireless power receiver to supply power to the portable electronic device, comprising a pouch having a wireless power transmitter and a battery source, wherein the wireless power transmitter is configured to transmit power from the battery source to the wireless power receiver when the portable electronic device is positioned within the pouch.

In Example 8, the subject matter of Example 7 can optionally include that the pouch includes a first side and a second side, wherein the wireless power transmitter and the battery source are embedded in the first side.

In Example 9, the subject matter of Examples 7 and 8 can optionally include that the pouch is formed of a flexible material, wherein the first side comprises the wireless power transmitter and the battery source enclosed by the material.

In Example 10, the subject matter of Examples 7-9 can optionally include that the first and second sides have a length sufficient to extend across a length of the portable electronic device.

In Example 11, the subject matter of Examples 7-10 can optionally include that the wireless power transmitter is adjacent to a first surface on the first side at a position to locate the wireless power transmitter in power transmission range of the wireless power receiver when the portable electronic device is inserted in the pouch.

In Example 12, the subject matter of Examples 7-11 can optionally include that the pouch further includes: sidewalls extending between the first side and the second side; and an opening through which the portable electronic device is inserted.

Example 13 is a portable charging system for charging a portable electronic device, comprising: a power receiving case for the portable electronic device forming an enclosure in which the portable electronic device is inserted, comprising: an attachment structure for coupling to the portable electronic device; a wireless power receiver; a power interface coupling the wireless power receiver to an interface on the portable electronic to allow the transmission of power from the wireless power receiver to the portable electronic device when the portable electronic device is coupled to the power receiving case; and a portable charging station comprising: a wireless power transmitter; a battery source to supply power to the wireless power transmitter to transmit to the wireless power receiver; and an attachment structure to guide the portable electronic device coupled to the power receiving case to a position with respect to the portable charging station where the wireless power transmitter is in power transmission range with the wireless power receiver.

In Example 14, the subject matter of Example 13 can optionally include that the attachment structure comprises a base, a front surface of the base to engage the portable electronic device coupled to the power receiving case, a back surface of the base, and a first side and second side opposite the first side between the front and back surfaces, wherein the wireless power transmitter and the battery source are embedded in the base adjacent to the front surface and between the front and the back sides.

In Example 15, the subject matter of Examples 13 and 14 can optionally include that the battery source comprises a first battery located on a first side of the wireless power transmitter and a second battery located on a second side opposite the first side of the wireless power transmitter, wherein the first and second batteries supply power to the wireless power transmitter.

In Example 16, the subject matter of Examples 13-15 can optionally include that the attachment structure comprises a pouch in which the power receiving case engaging the portable electronic device is inserted.

In Example 17, the subject matter of Examples 13-16 can optionally include that a belt clip on an outer surface of a side of the portable charging station opposite an inner surface of the side, wherein the portable electronic device coupled to the power receiving case is engaged to the portable charging station adjacent to the inner surface of the side.

Example 18 is a method for charging a portable electronic device having a wireless power receiver, comprising: attaching a portable charging station to a clothing accessory of a user of the portable charging station, wherein the portable charging station comprises an attachment structure for coupling to the portable electronic device, a battery source, and a wireless power transmitter coupled to the battery source to transmit power from the battery source to the wireless power receiver of the portable electronic device; and engaging the portable electronic device to the portable charging station, wherein the attachment structure positions the portable electronic device in the portable charging station to cause the wireless power transmitter to transmit power from the battery source to the wireless power receiver.

In Example 19, the subject matter of Example 18 can optionally include that the portable electronic device includes a portable electronic device component and a portable power receiving case including the wireless power receiver, wherein the portable power receiving case forms an enclosure to receive the portable electronic device component, comprising: engaging the portable electronic device component to the portable power receiving case; inserting a power interface of the portable power receiving case to an interface on the portable electronic device to allow the transmission of power from the wireless power receiver to the portable electronic device, wherein engaging the portable electronic device to the portable charging station comprises coupling the portable power receiving case engaged with the portable electronic device component with portable charging station.

In Example 20, the subject matter of Examples 18 and 19 can optionally include that the attachment structure comprises a front surface to engage the portable electronic device, a back surface at which the portable charging station is attached to the clothing accessory, wherein the wireless power transmitter and the battery source are embedded in the portable charging station adjacent to the front surface and between the front and the back surfaces, and wherein engaging the portable electronic device to the portable charging station comprises positioning the wireless power receiver of the portable electronic device to be within power transmission range of the wireless power transmitter.

In Example 21, the subject matter of Examples 18-20 can optionally include that the portable charging station has a base in which the power transmitting receiver and battery source are embedded, wherein engaging the portable electronic device to the portable charging station comprises: positioning the portable electronic device against the base and between an adjustable first clip on a first side of the base and a second clip on a second side of the base opposite the first side; moving the adjustable first clip downwards to engage a first edge of the portable electronic device until both the adjustable first clip securely engages the first edge and the second clip securely engages a second edge of the portable electronic device opposite the first edge.

In Example 22, the subject matter of Examples 18-21 can optionally include that the attachment structure comprises a pouch, wherein engaging the portable electronic device with the portable charging station comprises positioning the portable electronic device in the pouch to a position where the wireless power receiver is in power transmission range of the wireless power transmitter.

In Example 23, the subject matter of Examples 18-22 can optionally include that the portable charging station has a belt clip to attach the portable charging station to the clothing accessory.

What is claimed:

1. A portable charging station for a portable electronic device having a wireless power receiver to supply power to the portable electronic device, comprising:
a base having a wireless power transmitter and a battery source providing power to the wireless power transmitter; and
an attachment structure to position the portable electronic device to engage the base at a location where the wireless power transmitter is in transmission range from the wireless power receiver, wherein the wireless power transmitter is configured to transmit power from the battery source to the wireless power receiver when the portable electronic device is engaged to the base by the attachment structure.

2. The portable charging station of claim 1, wherein the base includes a front surface to engage the portable electronic device and a back surface, and a first side and second side opposite the first side between the front and back surfaces, wherein the attachment structure comprises an adjustable first clip on the first side and a second clip on the second side, wherein the adjustable clip includes a shaft that is movable to position the adjustable clip away from the base.

3. The portable charging station of claim 1, wherein the base includes a front surface to engage the portable electronic device and a back surface, and a first side and second side opposite the first side between the front and back surfaces, and wherein the wireless power transmitter and the battery source are embedded in the base adjacent to the front surface and between the front and the back sides.

4. The portable charging station of claim 3, wherein the battery source comprises a first battery located on a first side of the wireless power transmitter and a second battery located on a second side opposite the first side of the wireless power transmitter, wherein the first and second batteries supply power to the wireless power transmitter.

5. The portable charging station of claim 4, wherein the base has a substantially rectangular shape and wherein the wireless power transmitter is positioned at substantially at a center of the base along a length of the base.

6. The portable charging station of claim 5, further comprising:
a belt clip on the back surface of the base to attach the portable charging station to a clothing accessory of a user.

7. A portable charging station for a portable electronic device having a wireless power receiver to supply power to the portable electronic device, comprising:
a pouch having a wireless power transmitter and a battery source, wherein the wireless power transmitter is configured to transmit power from the battery source to the wireless power receiver when the portable electronic device is positioned within the pouch.

8. The portable charging station of claim 7, wherein the pouch includes a first side and a second side, wherein the wireless power transmitter and the battery source are embedded in the first side.

9. The portable charging station of claim 8, wherein the pouch is formed of a flexible material, wherein the first side comprises the wireless power transmitter and the battery source enclosed by the material.

10. The portable charging station of claim 7, wherein the first and second sides have a length sufficient to extend across a length of the portable electronic device.

11. The portable charging station of claim 8, wherein the wireless power transmitter is adjacent to a first surface on the first side at a position to locate the wireless power transmitter in power transmission range of the wireless power receiver when the portable electronic device is inserted in the pouch.

12. The portable charging station of claim 8, wherein the pouch further includes:
sidewalls extending between the first side and the second side; and
an opening through which the portable electronic device is inserted.

13. A portable charging system for charging a portable electronic device, comprising:
a power receiving case for the portable electronic device forming an enclosure in which the portable electronic device is inserted, comprising:
an attachment structure for coupling to the portable electronic device;
a wireless power receiver;
a power interface coupling the wireless power receiver to an interface on the portable electronic to allow the transmission of power from the wireless power receiver to the portable electronic device when the portable electronic device is coupled to the power receiving case; and
a portable charging station comprising:
a wireless power transmitter;
a battery source to supply power to the wireless power transmitter to transmit to the wireless power receiver; and
an attachment structure to guide the portable electronic device coupled to the power receiving case to a position with respect to the portable charging station where the wireless power transmitter is in power transmission range with the wireless power receiver.

14. The portable charging system of claim 13, wherein the attachment structure comprises a base, a front surface of the base to engage the portable electronic device coupled to the power receiving case, a back surface of the base, and a first side and second side opposite the first side between the front and back surfaces, wherein the wireless power transmitter and the battery source are embedded in the base adjacent to the front surface and between the front and the back sides.

15. The portable charging system of claim 14, wherein the battery source comprises a first battery located on a first side of the wireless power transmitter and a second battery located on a second side opposite the first side of the wireless power transmitter, wherein the first and second batteries supply power to the wireless power transmitter.

16. The portable charging system of claim 14, wherein the attachment structure comprises a pouch in which the power receiving case engaging the portable electronic device is inserted.

17. The portable charging system of claim 13, further comprising:
a belt clip on an outer surface of a side of the portable charging station opposite an inner surface of the side, wherein the portable electronic device coupled to the power receiving case is engaged to the portable charging station adjacent to the inner surface of the side.

18. A method for charging a portable electronic device having a wireless power receiver, comprising:
attaching a portable charging station to a clothing accessory of a user of the portable charging station, wherein the portable charging station comprises an attachment structure for coupling to the portable electronic device, a battery source, and a wireless power transmitter coupled to the battery source to transmit power from the battery source to the wireless power receiver of the portable electronic device; and
engaging the portable electronic device to the portable charging station, wherein the attachment structure positions the portable electronic device in the portable charging station to cause the wireless power transmitter to transmit power from the battery source to the wireless power receiver.

19. The method of claim 18, wherein the portable electronic device includes a portable electronic device component and a portable power receiving case including the wireless power receiver, wherein the portable power receiving case forms an enclosure to receive the portable electronic device component, comprising:
engaging the portable electronic device component to the portable power receiving case;
inserting a power interface of the portable power receiving case to an interface on the portable electronic device to allow the transmission of power from the wireless power receiver to the portable electronic device,
wherein engaging the portable electronic device to the portable charging station comprises coupling the portable power receiving case engaged with the portable electronic device component with portable charging station.

20. The method of claim 18, wherein the attachment structure comprises a front surface to engage the portable electronic device, a back surface at which the portable charging station is attached to the clothing accessory, wherein the wireless power transmitter and the battery source are embedded in the portable charging station adjacent to the front surface and between the front and the back surfaces, and wherein engaging the portable electronic device to the portable charging station comprises positioning the wireless power receiver of the portable electronic device to be within power transmission range of the wireless power transmitter.

21. The method of claim 18, wherein the portable charging station has a base in which the power transmitting receiver and battery source are embedded, wherein engaging the portable electronic device to the portable charging station comprises:
positioning the portable electronic device against the base and between an adjustable first clip on a first side of the base and a second clip on a second side of the base opposite the first side;
moving the adjustable first clip downwards to engage a first edge of the portable electronic device until both the adjustable first clip securely engages the first edge and the second clip securely engages a second edge of the portable electronic device opposite the first edge.

22. The method of claim 18, wherein the attachment structure comprises a pouch, wherein engaging the portable electronic device with the portable charging station comprises positioning the portable electronic device in the pouch to a position where the wireless power receiver is in power transmission range of the wireless power transmitter.

23. The method of claim 18, wherein the portable charging station has a belt clip to attach the portable charging station to the clothing accessory.
